(19) United States
(12) Patent Application Publication
(10) Pub. No.: US 2026/0154193 A1
(43) Pub. Date: Jun. 4, 2026

(54) HIGH-BANDWIDTH HYBRID STACKED MEMORY

(71) Applicant: International Business Machines Corporation, Armonk, NY (US)

(72) Inventors: Todd Edward Takken, YORKTOWN HEIGHTS, NY (US); Robert K. Montoye, YORKTOWN HEIGHTS, NY (US); Yutaka Nakamura, Albany, NY (US)

(21) Appl. No.: 18/968,353

(22) Filed: Dec. 4, 2024

(51) Int. Cl. G06F 12/02

(52) U.S. Cl. CPC G06F 12/0246

(57) ABSTRACT

An example operation includes one or more of receiving a request for access to data stored within a chip stack that comprises a plurality of dynamic random-access memory (DRAM) chips which are communicably coupled to a substrate, and a NOT AND (NAND) flash memory chip which is communicably coupled to the plurality of DRAM chips, and accessing the data within the chip stack based on the plurality of DRAM chips and the NAND flash memory chip within the chip stack.

### BACKGROUND

High bandwidth memory (HBM) is a type of dynamic random-access memory (DRAM) that offers faster data access with lower energy consumption in comparison to other types of memory such as non-volatile memory. HBM chips can be arranged in a stacked architecture to achieve high-speed data access, including transfers, writes, reads, etc. The stacks of HBM chips can be used to improve performance and to reduce power consumption for larger processing operations such as those for the purposes of artificial intelligence. However, HBM has some limitations. In particular, the capacity of an HBM chip is significantly smaller than that of other storage types, such as certain non-volatile memory.

### SUMMARY

One example embodiment provides an apparatus that may include one or more of a substrate, a plurality of dynamic random-access memory (DRAM) chips disposed in a chip stack that is communicably coupled to the substrate, and a NOT AND (NAND) flash memory chip that is included in the chip stack and which is communicably coupled to the plurality of DRAM chips.

Another example embodiment provides a method that may include one or more of receiving a request for access to data stored within a chip stack that comprises a plurality of dynamic random-access memory (DRAM) chips which are communicably coupled to a substrate, and a NOT AND (NAND) flash memory chip which is communicably coupled to the plurality of DRAM chips, and accessing the data within the chip stack based on the plurality of DRAM chips and the NAND flash memory chip within the chip stack.

A further example embodiment provides a computer-readable hardware storage medium that includes instructions which when executed by a processor cause the processor to perform computer operations that may include one or more of receiving a request for access to data stored within a chip stack that comprises a plurality of dynamic random-access memory (DRAM) chips which are communicably coupled to a substrate, and a NOT AND (NAND) flash memory chip which is communicably coupled to the plurality of DRAM chips, and accessing the data within the chip stack based on the plurality of DRAM chips and the NAND flash memory chip within the chip stack.

### BRIEF DESCRIPTION OF THE DRAWINGS

FIG. 1 is a diagram illustrating a computing environment according to an embodiment of the instant solution.

FIG. 2A is a diagram illustrating an architecture of a hybrid chip stack according to examples and features of the instant solution.

FIG. 2B is a diagram illustrating another architecture of a hybrid chip stack according to additional examples and features of the instant solution.

FIG. 2C is a diagram illustrating a process of executing an operation using the hybrid chip stack according to examples and features of the instant solution.

FIG. 3 is a diagram illustrating a process performed by an interposer chip of the hybrid chip stack according to examples and features of the instant solution.

FIG. 4A is a flow diagram illustrating a method according to examples and features of the instant solution.

FIG. 4B is a flow diagram illustrating a method according to additional examples and features of the instant solution.

FIG. 5A is a system diagram illustrating integration of an AI model into any decision point according to the examples and features of the instant solution.

FIG. 5B is a diagram illustrating a process for developing an AI model that supports AI-assisted computer decision points according to the examples and features of the instant solution.

FIG. 5C is a diagram illustrating a process for utilizing an AI model that supports AI-assisted computer decision points according to examples and features of the instant solution.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

High bandwidth memory (HBM) is a type of dynamic random-access memory (DRAM) or synchronous dynamic random-access memory (SDRAM) that can accelerate AI computing. For example, HBM chips may be stacked together and coupled to a neighboring processor chip. This configuration exemplifies an AI accelerator module that integrates processor chips and HBM memory stacks, with both components arranged laterally on a shared substrate, such as an integrated circuit. However, while the use of HBM can accelerate AI processing, an HBM's capacity is insufficient to accommodate modern AI software models within the memory space of a single accelerator module. As a result, it is common for an AI software model to be distributed across multiple accelerator modules, which must communicate during execution. This distribution leads to increased processing costs, higher power consumption, and greater requirements for high-speed interconnections.

Meanwhile, NOT AND (NAND) flash memory chips are high-density storage technology with significantly greater storage capacity than DRAM (and HBM). However, NAND flash has limited read bandwidth, write bandwidth, and write endurance, which makes it impractical to use as the sole non-SRAM high-capacity memory type in an AI accelerator module. Furthermore, a NAND flash memory chip and a DRAM chip operate using different voltages. Moreover, read bandwidths of a NAND flash memory chip and the DRAM chip differ so significantly that using them together is challenging.

The example embodiments are directed to a hybrid chip stack that incorporates the benefits of HBM and NAND flash memory. In particular, a stack of DRAM chips can be combined with a NAND flash memory chip using interposer technology, in order to create a FLASH-SDRAM chip stack, also referred to herein as a high-bandwidth flash (HBF). The HBF also includes a standard interface that allows the HBF to be interconnected and easily integrated into future chiplet-based MCMs (multichip modules).

For example, the hybrid chip stack described herein may include a plurality of HBM chips as the DRAM which is disposed in a chip stack that is communicably coupled to a substrate such as an integrated circuit (IC) or the like. The chip stack also includes a NAND flash memory chip that is included at a top of the chip stack and which is communicably coupled to the plurality of HBM chips. The communicative coupling between the plurality of HBM chips and the NAND flash memory chip can include different architectures.

For example, the plurality of HBM chips may include through silicon vias (TSVs) which are known in the art. In many cases, HBM chips are stacked in quadrants (groups of four) and TSVs are configured to run through entire quadrants of HBM chips. In this example, the NAND flash memory may be configured to be communicably coupled to the plurality of HBM chips within the chip stack through the TSVs. For example, the NAND flash memory chip can be manufactured with a similar TSV that runs partially through the NAND flash memory, and which aligns with the TSVs of the HBM chips. As another example, the plurality of HBM chips may be communicably coupled to the NAND flash memory chip through wire bonds. In this latter example, the NAND flash memory chip does not need to contain TSVs.

According to various embodiments, the hybrid chip stack may include an interposer chip that is disposed in between the plurality of HBM chips (or DRAM chips) and the NAND flash memory within the stack. Here, the interposer chip may be configured to translate signals sent between the plurality of HBM chips and the NAND flash memory. For example, the interposer chip may translate memory space allocation, formatting, and the like, which differs between the NAND flash memory chip and the HBM chips. Thus, the interposer chip can ensure that the communication and data transfer/access between the HBM chips and the NAND flash memory chip are performed successfully. For example, the interposer chip may include logic that is configured to receive a read request from the plurality of HBM chips and control how data is read from the NAND flash memory based on the read request.

The hybrid chip stack may also include an interface chip disposed underneath or at the bottom of the plurality of HBM chips. The interface chip may provide an interface that can attach to and communicatively couple with the substrate. Here, the substrate may also include a processor chip (e.g., processing core, processing module, etc.) that is disposed on the substrate and which is communicably coupled to the chip stack via the interface chip. In some embodiments, the processor chip may execute an artificial intelligence (AI) process utilizing the hybrid chip stack that is communicably coupled to the processor chip.

The hybrid chip stack described herein may be disposed on computing nodes of a host platform such as a cloud platform, a web server, a database, or the like.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).
Rapid elasticity: capabilities can be rapidly and elastically provisioned, in some cases automatically, to quickly scale out and rapidly released to quickly scale in. To the consumer, the capabilities available for provisio. ning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure, including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure, including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer can deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community with shared concerns (e.g., mission, security requirements, policy, and compliance considerations). It may be managed by organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Thus, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the diagrams, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

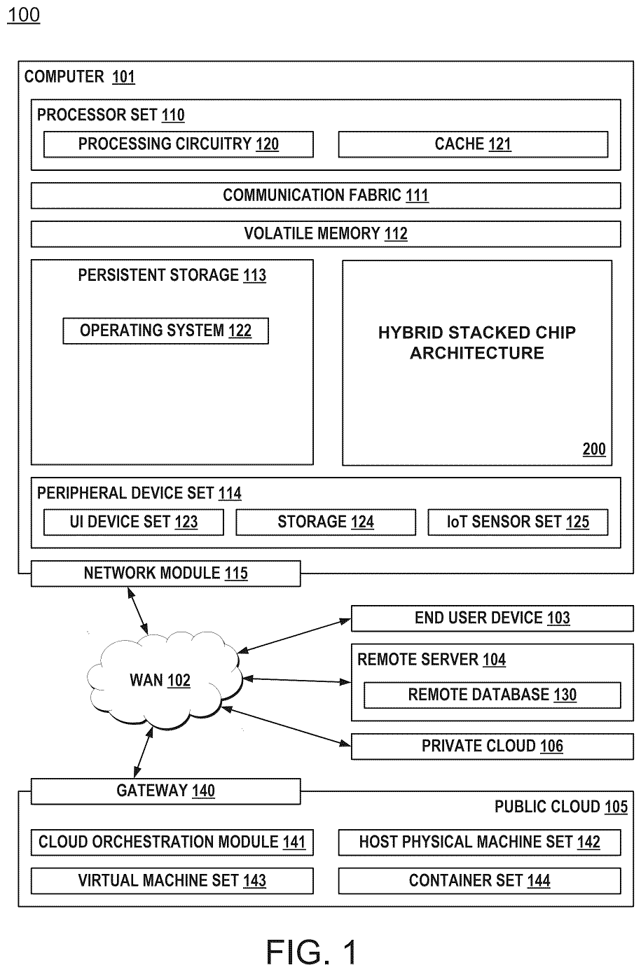

FIG. 1 illustrates a computing environment 100 according to an embodiment of the instant solution. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring to FIG. 1, computing environment 100 contains an example of an environment for executing at least some of the computer code involved in performing the inventive methods, such as hybrid stacked chip architecture 200. In addition to block 200, computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smartphone, smartwatch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, the performance of a computer-implemented method may be distributed among multiple computers and/or between multiple locations. On the other hand, in this presentation of the computing environment 100, a detailed discussion is focused on a single computer, specifically the computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is a memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric comprises switches and electrically conductive paths, such as the switches and electrically conductive paths that make up buses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface type operating systems that employ a kernel.

The hybrid stacked chip architecture 200 may include HBM chips that are stacked together with a NAND chip, or the like, and an interposer chip disposed between the HBM chips and the NAND chip. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth® connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smartwatches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi® signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data now known or to be developed in the future. In some embodiments, the WAN may be replaced and/or supplemented by local area networks (LANs) designed to communicate data between devices located in a local area, such as a Wi-Fi® network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, this data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanations of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as communicating with WAN 102, in other embodiments, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both parts of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The example embodiments are directed to a hybrid chip stack that combines a stack of HBM chips with a NAND flash memory chip, which can increase the capacity of a traditional chip stack by one to two orders of magnitude (e.g., 10 to 100 times more capacity, etc.) The NAND flash memory chip may be coupled to the HBM stack through various architectures.

For example, in a first embodiment, minimal modifications are needed to the NAND flash memory chip. The NAND flash memory chip may include multi-bit per cell technology. As an example, the NAND flash memory chip may include a multi-level cell (MLC) architecture, a quad-level cell (QLC) architecture, a penta-level cell (PLC) architecture, or the like. In some embodiments, the MLC architecture may be used but embodiments are not limited thereto. The system may use control firmware to operate the NAND flash memory chip in pseudo-SLC mode, interpreting higher voltage levels from the cell as logical 1 and lower voltage levels as logical 0. The only modification to the NAND flash memory chip would be to adjust the cell count so that the NAND flash memory chip dimensions are the same as or slightly smaller than those of a standard HBM memory chip.

In this example, the NAND flash memory chip may be coupled to the periphery of an interposer chip. The HBM stack may be coupled to the opposite side/periphery of the interposer chip. The interposer chip may have the same lateral dimensions as an unmodified HBM chip. The interposer chip may contain through silicon vias (TSVs) just as HBM chips include, and the interposer chip may attach to the HBM stack using the same micro-bump or copper-to-copper bonding technology as used in a standard HBM chip stack. The HBM stack may only contain a fraction of the full number of HBM chips that are typically stacked in a standard HBM-only stack. For example, the HBM stack may include four out of eight, six out of eight, six out of 12 or nine out of 12 HBM chips, however, embodiments are not limited thereto. For example, one quadrant of HBM chips may be left unpopulated.

In addition, an interface chip may be disposed on the bottom of the HBM stack and may connect the hybrid chip stack to a substrate such as an integrated circuit card (ICC). The interposer chip may contain an SRAM cache, decoupling capacitance, power conversion to provide FLASH-specific voltages from the power vias sourcing 1.2 V or the then-current main HBM supply voltage and logic circuits. Logic circuits in the interposer chip could provide preprocessing near memory. Logic circuits in the interface chip may provide HBM-format, high-speed serial or UCIe communications to other chips or chip stacks on the module. The interface chip could also provide more substantial CPU or accelerator functions.

In second embodiment, the architecture would further modify the NAND flash memory chip by designing the flash cells and read-write circuitry to operate in a single-bit-per-cell or SLC mode. The SLC flash may increase the write endurance and would decrease the read and write bandwidths to the storage cells. Further changes to the architecture for HBF could increase the number of data wires routed from the storage cells and could increase the strength and the bandwidth of the read-write circuitry. In a third embodiment, the NAND flash memory chip may include TSVs as do the HBM chips. For a brief time early in the development of 3D FLASH, the FLASH chips were made with TSVs. If the HBF's FLASH chip's TSV pattern were designed to match the contact pattern of HBM TSVs, then this would permit eliminating the interposer chip as a cost savings.

The combination of the NAND flash memory chip on top of the HBM stack, with the interposer chip in between, can create significant increases in capacity for processing operations of a processing chip on the same substrate without sacrificing speed. As previously noted, the capacity of the hybrid chip stack may have a capacity that is one to two orders of magnitude greater than a HBM stack without the NAND flash memory chip.

There are a number of new features included in the example embodiments including, but not limited to, a NAND flash memory chip and HBM chips being included in the same chip stack. For example, where the HBM TSVs may be used to pass data to the NAND flash memory chip. The NAND flash memory chip may be optimized for high read bandwidth. The NAND flash memory chip may be operated in a single-bit-per-cell (SLC) mode. In some embodiments, the hybrid stack may include functionality such as at least one of a SRAM to server as a cache (for the NAND flash memory chip), decoupling functionality, power conversion functionality, logic circuits that provide computation for processing near memory, and the like. The additional functionality may be included in a bulk silicon layer of the NAND flash memory chip. As another example, the additional functionality may be included in the interposer chip.

The example embodiments also newly introduce an interposer chip that is located between the HBM stack and the NAND flash memory chip. The interposer chip may include logic circuits that are fabricated in a performance-optimized logic technology, not a capacity-optimized memory technology. In some embodiments, the hybrid stack may contain an interface chip that manages signals sent to and received from devices that are not in the HBF stack. The interface chip may be disposed at the bottom of the hybrid stack. The interface chip may communicate outside the hybrid stack, for example, using UCIe signaling protocols. In some embodiments, the interface chip may contain logic circuits for processing near memory.

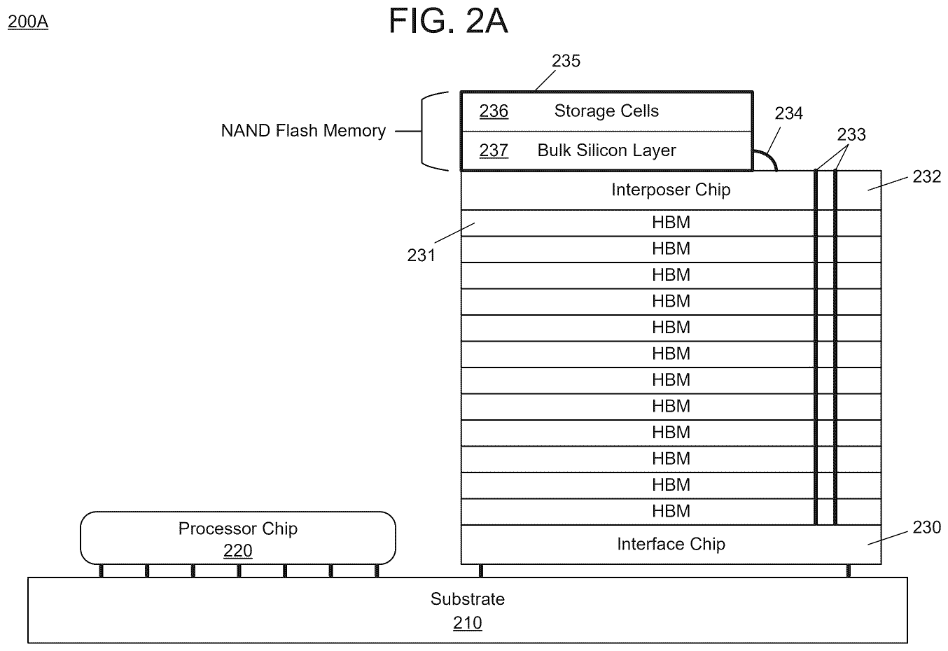

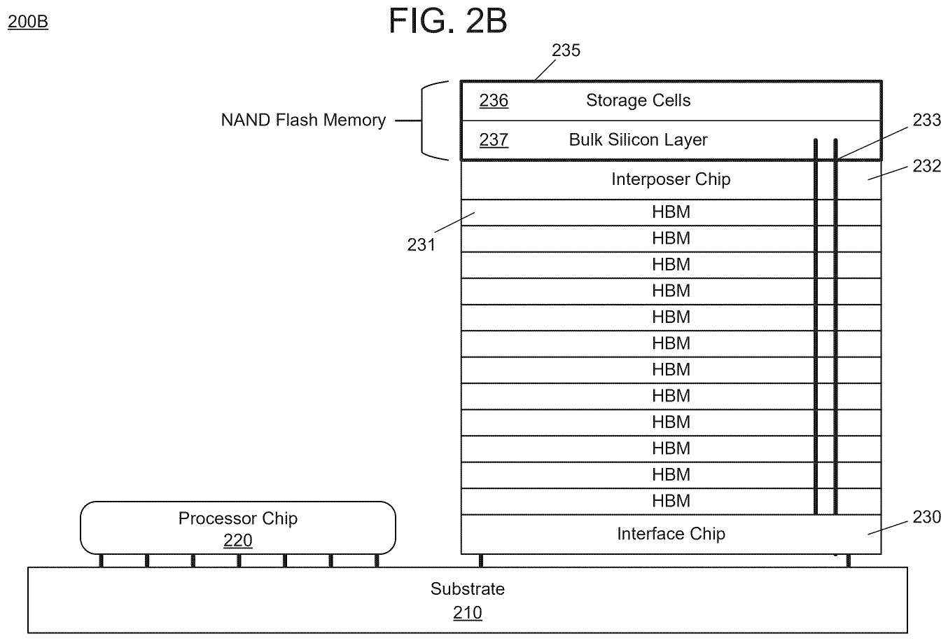

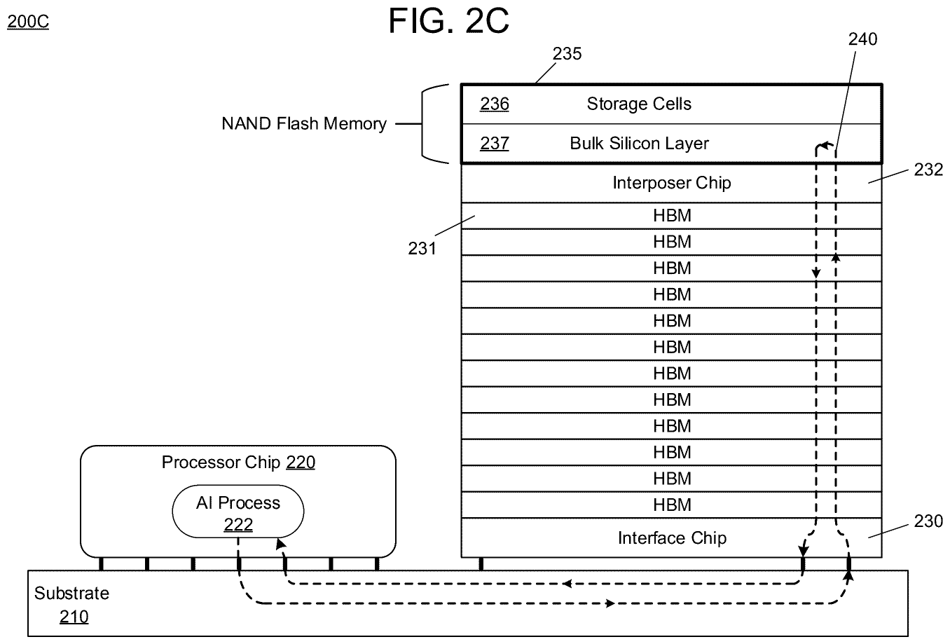

FIG. 2A illustrates an architecture 200A of a hybrid chip stack according to examples and features of the instant solution. Referring to FIG. 2A, a hybrid chip stack is shown which includes an interface chip 230, a plurality of HBM chips 231, and a NAND flash memory chip 235 stacked on top of each other, respectively. In between the NAND flash memory chip 235 and the plurality of HBM chips 231 is an interposer chip 232. The interposer chip 232 may manage memory access between the NAND flash memory chip 235 and the plurality of HBM chips 231. The NAND flash memory chip 235 includes an array of storage cells 236 and a bulk silicon layer 237.

In this example, the hybrid chip stack is coupled to a substrate 210, for example, an integrated circuit. The hybrid chip stack may connect to the substrate 210 via the interface chip 230 which may include electrical connections that connect the substrate 210 and the plurality of HBM chips 231. In this example, the plurality of HBM chips 231 may include through silicon vias (TSVs) 233 which transfer data between the plurality of HBM chips 231. In this example, the interposer chip 232 also includes the TSVs 233 enabling the interposer chip 232 to receive data from the plurality of HBM chips 231. The TSVs 233 may include electrical connections (vias) that pass completely through the wafer of each HBM chip 231. The TSVs 233 may be vertical connections that are high-performance interconnects in comparison to wire bonds.

In the example of FIG. 2A, the TSVs 233 are disposed on one side of the HBM chips 231. However, it should be appreciated that the HBM chips 231 may include multiple groups of TSVs 233 which are disposed in multiple different locations in the HBM chips 231. As an example, each HBM chip 231 may include four groups of TSVs 233 in four quadrants of the HBM chip 231, however, embodiments are not limited thereto.

In this example, the NAND flash memory chip 235 is connected to the interposer chip 232 and the plurality of HBM chips 231 through a wire bond 234. The wire bond 234 enables data to flow from the plurality of HBM chips 231, through the interposer chip 232, to the bulk silicon layer 237 of the NAND flash memory chip 235. The wire bonds 234 may be added to the structure during manufacture or afterward.

The plurality of HBM chips 231 may include storage that stores data in smaller units than in comparison to the array of storage cells 236 of the NAND flash memory chip 235. The interposer chip 232 may contain logic which manages reads, writes, accesses, deletes, and the like, between the plurality of HBM chips 231 and the NAND flash memory chip 235. For example, the logic may translate the size of the memory being read in the NAND flash memory chip 235 based on a size of a storage unit of an HBM chip 231.

The substrate 210 also includes a processor chip 220 that is coupled to the substrate 210. The coupling may enable the processor chip 220 to send signals, data, communications, and the like, from the processor chip 220 to the hybrid stack for processing. For example, the processor chip 220 may request data from the hybrid stack. In response, the request may be processed using a combination of the plurality of HBM chips 231, the interposer chip 232, and the NAND flash memory chip 235.

FIG. 2B illustrates another architecture 200B of a hybrid chip stack according to additional examples and features of the instant solution. Referring to FIG. 2B, in this example, interface chip 230, the plurality of HBM chips 231, and the interposer chip 232 are communicably coupled to each other using the TSVs 233. In addition, the NAND flash memory chip 235 is designed with an interface that can mate with the TSVs 233 enabling the TSVs 233 to run from the plurality of HBM chips 231 to the NAND flash memory chip 235, via the interposer chip 232. Therefore, the data, communications, requests, etc. between the plurality of HBM chips 231 and the NAND flash memory chip 235 may be transferred through the TSVs 233.

The examples shown in FIG. 2B and FIG. 2A are both possible and are both considered significant improvements in capacity of a traditional HBM stack, without sacrificing access times.

FIG. 2C illustrates a process 200C of executing an operation using the hybrid chip stack according to examples and features of the instant solution. For example, operations that are executed by the processor chip 220 may use the storage included in the hybrid stack. Data may be transferred from the NAND flash memory chip 235 to the processor chip 220, and vice versa, via the hybrid stack described herein.

Referring to FIG. 2C, the processor chip 220 may receive a request from a software application to execute an artificial intelligence (AI) process 222. The AI process 222 may be an inference process, a training process, a fine-tuning process, a prompting process, a data conversion process, an embedding process, and the like. Although not shown in FIG. 2C, other processes may be performed on the processor chip 220 which rely on the hybrid stack such as video streaming tasks, blockchain mining tasks, and the like.

In this example, the AI process 222 requests data from the NAND flash memory chip 235, and in particular from the array of storage cells 236 included in the NAND flash memory chip 235. Here, the request for a data flow path 240 from the processor chip 220, through the substrate 210 (e.g., via circuitry, leads, etc.), to the interface chip 230 of the hybrid stack. Furthermore, the data flow path 240 flows from the interface chip 230 to the plurality of HBM chips 231, to the interposer chip 232, and to the NAND flash memory chip 235, via the TSVs 233. The interposer chip 232 may control the size of the data that is retrieved and the space of the array of storage cells 236 that are searched for the data. In response, the data may be returned to the AI process 222 via the same data flow path 240, just in a reverse direction.

In this example, the interface chip 230 and the substrate 210 have area-array ball contacts. In this example, the signal pins of the interface chip 230 are on a periphery of an underneath side of the interface chip 230 which connects to the substrate 210. In this example, the periphery of the interface chip 230 may send signals into the substrate 210. One of the functions of the interface chip 230 is to be a space transformer, format transformer and signal re-driver interface between its top surface HBM TSV contacts (in the middle of the interface chip's area) and its bottom surface contacts to the substrate 210 (at the periphery of the interface chip's area).

In the example of FIG. 2C, the same wires (or same passive electrical connections) continue vertically through both the interposer and interface chips. In actuality, each of those two chips 232 and 230 may perform some format translation (with logic in between the in and out ports), data rate change and signal redrive. Therefore, it may be unlikely to be a direct connection through either the interface chip 230 or the interposer chip 232, but is shown this way for ease of understanding.

This process shown in FIG. 2C may be iteratively repeated during a predictive process, training process, embedding process, or the like of the AI process 222.

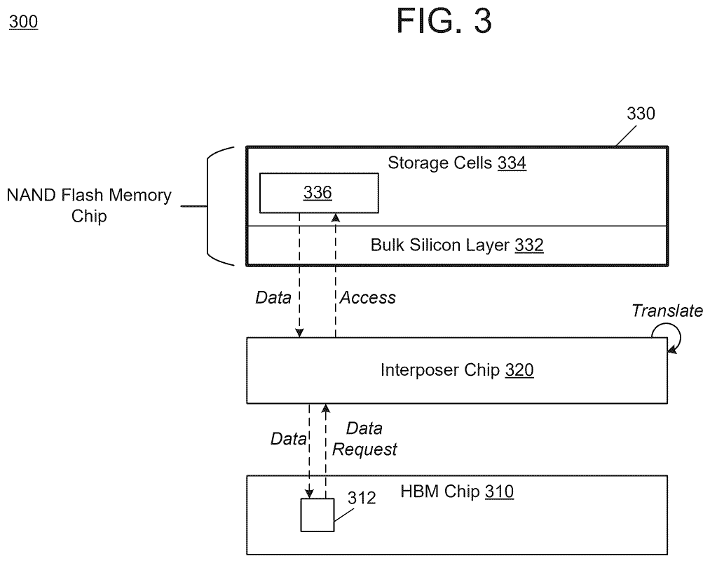

FIG. 3 illustrates a process 300 performed by an interposer chip 320 of the hybrid chip stack according to examples and features of the instant solution. For example, the interposer chip 320 shown in FIG. 3 may correspond to the interposer chip 232 that is shown and described with respect to FIGS. 2A-2C. In this example, the interposer chip 232 is sandwiched between a NAND flash memory chip 330 that is disposed above the interposer chip 320 (along a first surface/side) and a plurality of HBM chips including an HBM chip 310 disposed below the interposer chip 320 (along a second surface/opposite side). The NAND flash memory chip 330 includes a bulk silicon layer 332 and an array of storage cells 334 where data is contained/stored.

Referring to FIG. 3, the interposer chip 320 may contain logic that enables the interposer chip 320 to perform memory management of the array of storage cells 334 and translate data requests that are submitted by any of the plurality of HBM chips in the chip stack, such as the HBM chip 310. Here, the translation process may include changing a size of the memory that is accessed within array of storage cells 334 of the NAND flash memory chip 330. In addition, the interposer chip 320 may perform a space transformation in a situation where the interface of the NAND flash memory chip 330 is not the same size, shape, dimension, etc. as the interface of the HBM chip 310.

In this case, the NAND flash memory chip 330 stores data in larger blocks than in comparison to the HBM chip 310. For example, the HBM chip 310 may store blocks 312 of data that are smaller than blocks 336 of data that are stored in the NAND flash memory chip 330. The interposer chip 320 may determine how much to read from the larger block in the NAND flash memory chip 330, how much to discard from the block, and the like.

The interposer chip 320 may perform various functions. For example, the interposer chip 320 may function as a space transformer. The topside of the interposer chip 320 contacts to the FLASH chip and a bottom side of the interposer chip 320 contacts an HBM stack that have contacts in different positions than the FLASH chip. If the contacts to the FLASH are wire bonds from peripheral pads (not the only option), and if the contacts to the HBM are TSV pads on an HBM-defined list of locations, then the interposer may be used to connect these two.

The interposer chip 320 may also function as a format translator. The FLASH includes large storage blocks with slower access times. The HBM TSVs might be either HBM or some other custom communications format (if the HBM stack is a partial stack and the vias are not connected to the HBM logically). The interposer chip 320 contains buffering and formatting translation logic.

The interposer chip 320 may also function as a voltage converter. The FLASH chip may require voltages that are different from those of an HBM. The interposer chip 320 can provide voltage conversion, in order to convert voltage signals from the HBM to those of the different voltages of the FLASH chip, and vice-versa. The interposer chip 320 may also have voltage regulation and/or decoupling capacitance features. The interposer chip 320 may also provide computer-near-memory functions. It could potentially be a copy of the bottom-of-stack interface chip, with only one new mask to change its contacts slightly.

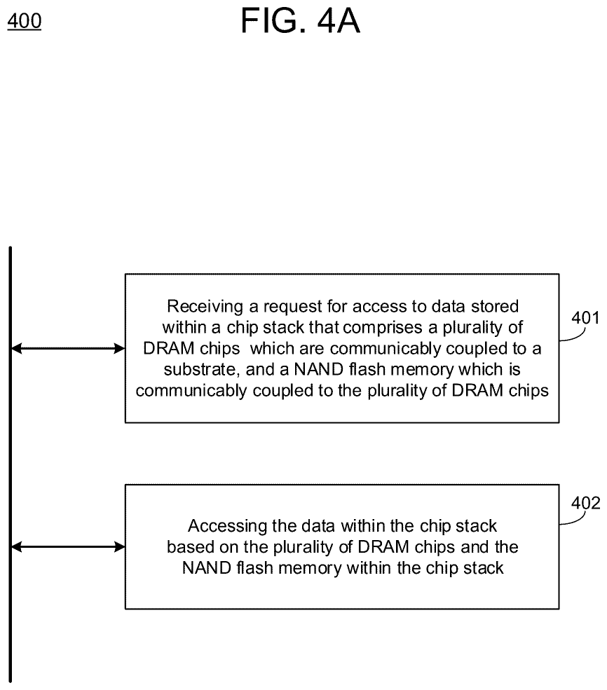

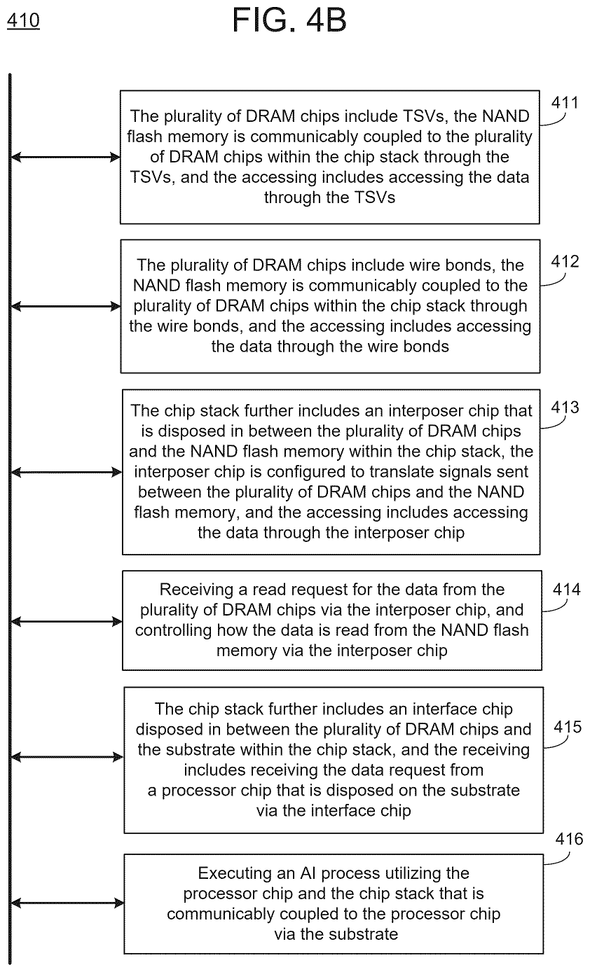

FIG. 4A illustrates a flow diagram of a method 400, according to example embodiments. Referring to FIG. 4A, in 401, the method may include receiving a request for access to data stored within a chip stack that comprises a plurality of dynamic random-access memory (DRAM) chips which are communicably coupled to a substrate, and a NOT AND (NAND) flash memory which is communicably coupled to the plurality of DRAM chips. In 402, the method may include accessing the data within the chip stack based on the plurality of DRAM chips and the NAND flash memory within the chip stack.

FIG. 4B illustrates a flow diagram of a method 410, according to example embodiments. Referring to FIG. 4B, in 411, the plurality of DRAM chips include through silicon vias (TSVs), the NAND flash memory is communicably coupled to the plurality of DRAM chips within the chip stack through the TSVs, and the accessing the data may include accessing the data through the TSVs. In 412, the plurality of DRAM chips include wire bonds, the NAND flash memory is communicably coupled to the plurality of DRAM chips within the chip stack through the wire bonds, and the accessing the data may include accessing the data through the wire bonds.

In 413, the chip stack may include an interposer chip that is disposed in between the plurality of DRAM chips and the NAND flash memory within the chip stack, where the interposer chip is configured to translate signals sent between the plurality of DRAM chips and the NAND flash memory, and the accessing the data may include accessing the data through the interposer chip. In 414, the method may include receiving a read request for the data from the plurality of DRAM chips via the interposer chip, and controlling how the data is read from the NAND flash memory via the interposer chip.

In 415, the chip stack may further include an interface chip disposed in between the plurality of DRAM chips and the substrate within the chip stack, and the receiving the data request may include receiving the data request from a processor chip that is disposed on the substrate via the interface chip. In 416, the method may include executing an artificial intelligence (AI) process utilizing the processor chip and the chip stack that is communicably coupled to the processor chip via the substrate.

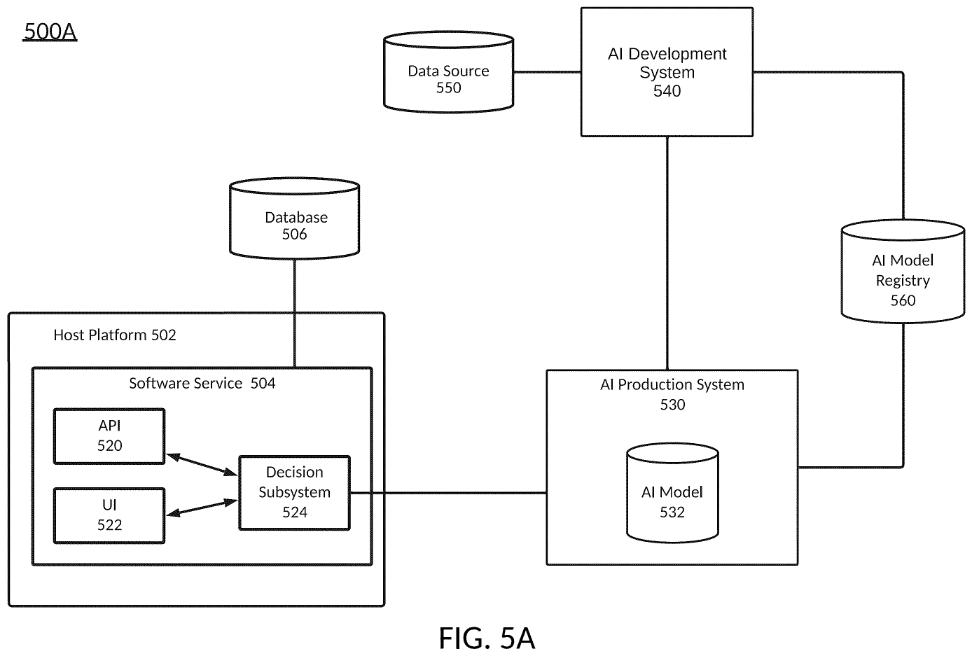

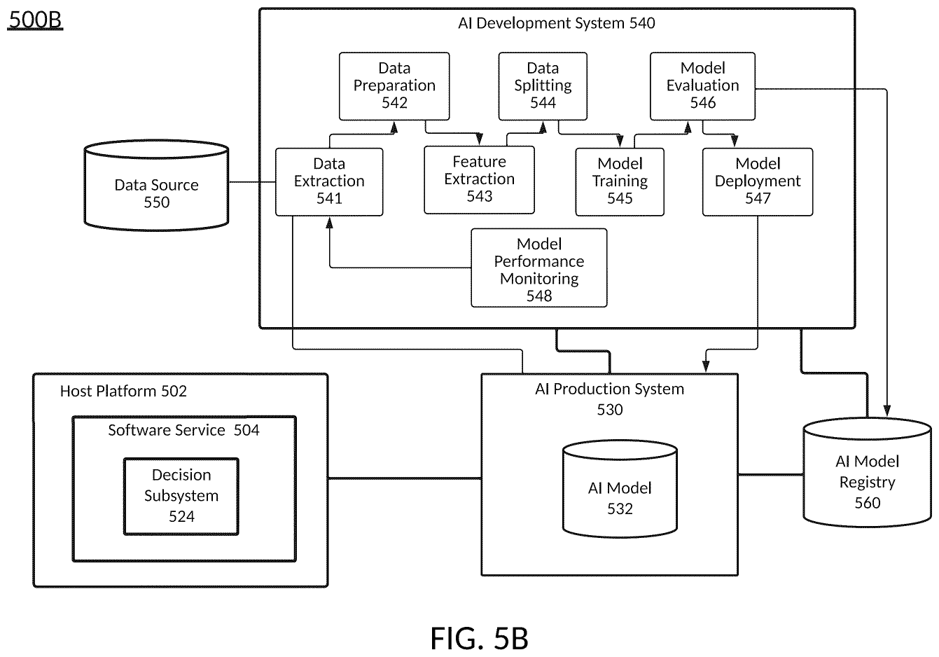

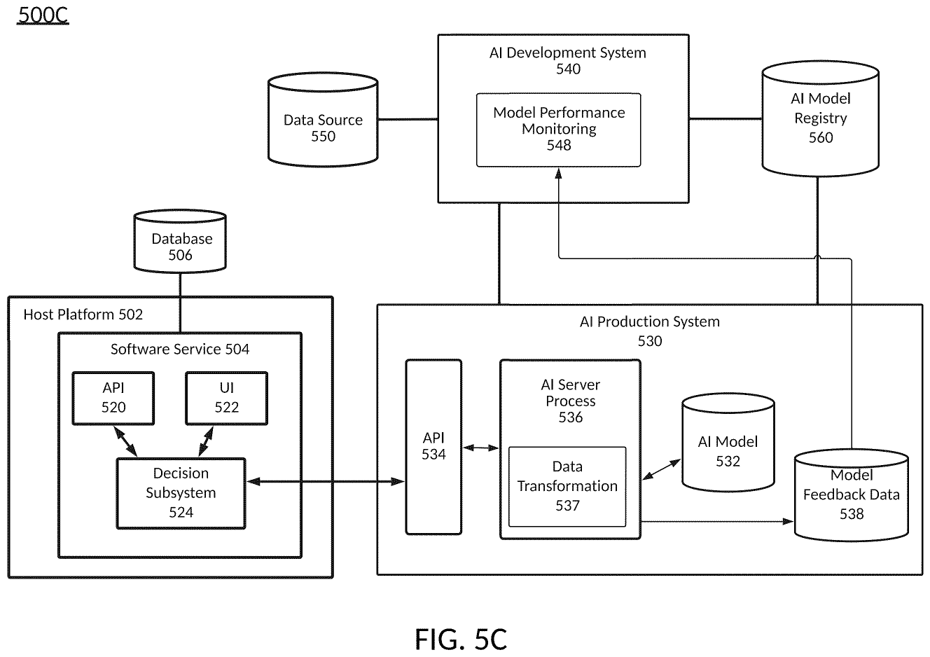

Detailed descriptions of training a machine learning model and executing a machine learning model are further described and depicted herein. The hybrid chip stack described herein may be used to process any of the steps that are described with respect to FIGS. 5A-5C, including executing an AI/ML model for purposes of inference, training, fine-tuning, and the like.

FIG. 5A illustrates an artificial intelligence (AI) network diagram 500A that supports AI-assisted decision points in a software service executing on a computer. As one example, the AI model being trained in the examples herein may refer to an AI model for any of the tasks performed herein including a machine learning model, a neural network, a large language model (LLM), and the like. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies, and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI models refer to present-day AI models and future AI models.

Artificial intelligence systems have been built and trained to perform various tasks in an automated manner. For example, artificial intelligence systems receive and understand verbal and/or written dialogue and function as digital assistants, speech-to-text programs, etc. Other artificial intelligence systems are trained on different types of information to allow the trained system to generate content—such as new works of art based on the styles seen, or new compound ideas based on the history of chemical research.

Foundation models are types of artificial intelligence systems that are trained on a broad set of unlabeled data that can be used for different tasks, with minimal fine-tuning. The unlabeled data includes in some instances imagery and/or language. In response to a short prompt being input into the foundation model, the system generates an output such as an entire essay, or a complex image, based on the parameters that are set forth in the input prompt. The foundation model is able to produce an output that attempts to meet the parameters even if the foundation model was never trained with specific training data that included the exact parameters, e.g., was never trained for that exact argument or to generate an image in that way.

Using self-supervised learning and transfer learning, foundation models can apply information that they have learnt about one situation to another. For example, like a human learns how to drive on one car, for example, and without too much effort, could learn how to drive other types of vehicles such as other cars, a truck, or a bus. The foundation model similarly is used to achieve proficiency in some new area without having to be trained completely from scratch. Foundation models seem to have inherent creativity in performing tasks such as stringing together coherent arguments or creating entirely original pieces of art. Foundation models are established in the technology of natural-language processing. One example of how foundation models are helpful is that for previous generation of AI techniques, if you wanted to build an AI model that could summarize bodies of text for you, you would need tens of thousands of labeled examples just for the summarization use case. With a pre-trained foundation model, the labeled data requirements are dramatically reduced. First, the foundation model is fine-tuned with a domain-specific unlabeled corpus to create a domain-specific foundation model. Then, using a much smaller amount of labeled data, potentially just a thousand labeled examples, a foundation model is trained for summarization. The domain-specific foundation model can be used for many tasks as opposed to the previous technologies that required building models from scratch in each use case. Foundation models are even applicable in areas such as computer programming coding analysis, generation, and repair.

Some foundation models are used for sentiment analysis. With pre-trained foundation models, sentiment analysis on a new language can be trained using as little as a few thousand sentences—100 times fewer annotations required than previous models. Reducing labeling requirements will make it much easier for implementation in various technical areas. Systems that execute specific tasks in a single domain are giving way to broad AI that learns more generally and works across domains and problems. Foundation models, trained on large, unlabeled datasets and fine-tuned for an array of applications, are driving this shift.

Large language models (LLMs) are a category of foundation models trained on immense amounts of data making them capable of understanding and generating natural language and other types of content to perform a wide range of tasks. LLMs have been implemented at different levels to enhance their natural language understanding (NLU) and natural language processing (NLP) capabilities. This advancement of LLMs has occurred alongside advances in machine learning, machine learning models, algorithms, neural networks, and the transformer models that provide the architecture for these AI systems.

LLMs are a class of foundation models, which are trained on enormous amounts of data to provide the foundational capabilities needed to drive multiple use cases and applications, as well as resolve a multitude of tasks. This LLM concept is in stark contrast to the idea of building and training domain specific models for each of these use cases individually, which is prohibitive under many criteria (most importantly cost and infrastructure), stifles synergies and can even lead to inferior performance.

LLMs represent a significant breakthrough in NLP and artificial intelligence. LLMs are accessible through interfaces like Open AI's Chat GPT-3 and GPT-4, which have garnered the support of Microsoft. Other examples include Meta's Llama models and Google's bidirectional encoder representations from transformers (BERT/RoBERTa) and PaLM models. IBM has also recently launched its Granite model series on watsonx.ai, which has become the generative AI backbone for other IBM products like watsonx Assistant and watsonx Orchestrate.

In a nutshell, LLMs are designed to understand and generate text like a human, in addition to other forms of content, based on the vast amount of data used to train them. They have the ability to infer from context, generate coherent and contextually relevant responses, translate to languages other than English, summarize text, answer questions (general conversation and FAQs) and even assist in creative writing or code generation tasks. LLMs are able to do some or all of these tasks thanks to many, e.g., billions of, parameters that enable them to capture intricate patterns in language and perform a wide array of language-related tasks. LLMs are revolutionizing applications in various fields, from chatbots and virtual assistants to content generation, research assistance and language translation.

LLMs operate by leveraging deep learning techniques and vast amounts of textual data. These models are typically based on a transformer architecture, like the generative pre-trained transformer, which excels at handling sequential data like text input. LLMs consist of multiple layers of neural networks, each with parameters that can be fine-tuned during training, which are enhanced further by a numerous layer known as the attention mechanism, which dials in on specific parts of data sets.

During the training process, these models learn to predict the next word in a sentence based on the context provided by the preceding words. The model does this through attributing a probability score to the recurrence of words that have been tokenized—broken down into smaller sequences of characters. These tokens are then transformed into embeddings, which are numeric representations of this context.

To ensure accuracy, this process involves training the LLM on a large corpus of text (e.g., in the billions of pages), allowing the LLM to learn grammar, semantics and conceptual relationships through zero-shot and self-supervised learning. Once trained on this training data, LLMs can generate text by autonomously predicting the next word based on the input they receive and drawing on the patterns and knowledge they have acquired. The result is coherent and contextually relevant language generation that can be harnessed for a wide range of NLU and content generation tasks.

Model performance can also be increased through prompt engineering, prompt-tuning, fine-tuning and other tactics like reinforcement learning with human feedback (RLHF) to remove the biases, hateful speech and factually incorrect answers known as “hallucinations” that are often unwanted byproducts of training on so much unstructured data. LLMs augment conversational AI in chatbots and virtual assistants to enhance the interactions that provide context-aware responses that mimic interactions with human agents.

LLMs also excel in content generation, automating content creation for blog articles, explanatory materials, and other writing tasks. LLMs aid in summarizing and extracting information from vast datasets, accelerating knowledge discovery. LLMs also play a vital role in language translation, breaking down language barriers by providing accurate and contextually relevant translations. LLMs can even be used to write code, or “translate” between programming languages. LLMs contribute to accessibility by assisting individuals with disabilities, including text-to-speech applications and generating content in accessible formats.

LLMs often include abilities such as:
Text generation: language generation abilities, such as writing emails, blog posts or other mid-to-long form content in response to prompts that can be refined and polished. An excellent example is retrieval-augmented generation (RAG).
Content summarization: summarize long articles, news stories, research reports, corporate documentation and even interaction history into thorough texts tailored in length to the output format.
AI assistants: chatbots that answer queries, perform backend tasks and provide detailed information in natural language as a part of an integrated, self-serve solution for handling inquiries.
Code generation: assists developers in building applications, finding errors in code and uncovering security issues in multiple programming languages, even “translating” between them.
Sentiment analysis: analyze text to determine a user's tone in order to understand user feedback at scale and aid in brand reputation management.
Language translation: provides wider coverage to organizations across languages and geographies with fluent translations and multilingual capabilities.

Software service 504 (see FIG. 5A), executing on host platform 502 (see FIG. 5A) may provide one or more application programming interfaces (APIs) 520 that enable interaction with other software components via a set of data definitions and protocols. In some examples and features of the instant solution, the APIs provided may employ Simple Object Access Protocol (SOAP), Remote Procedure Calls (RPC), and Representational State Transfer (REST) techniques. In some examples and features of the instant solution, the plurality of APIs 520 send data to one or more decision subsystems 524 of the software service 504 to assist in decision-making. In some examples and features of the instant solution, the software service 504 stores data included in API requests or data generated during processing the API requests into one or more databases 506 (see FIG. 5A).

Software service 504 may provide one or more user interfaces (UIs) 522, such as a server-side hosted graphical user interface (GUI). In some examples and features of the instant solution, the UIs 522 provided employ template-based frameworks, component-based frameworks, etc. In some examples and features of the instant solution, these UIs 522 send data to one or more decision subsystems 524 of the software service 504 to assist with decision-making. In some examples and features of the instant solution, the software service 504 stores data included in UI requests or data generated during processing the UI requests into one or more databases 506.

Software service 504 may include one or more decision subsystems 524 that drive a decision-making process of the software service 504. In some examples and features of the instant solution, the decision subsystems 524 receive data from one or more APIs 520 as input into the decision-making process. In some examples and features of the instant solution, a decision subsystem 524 may receive data from one or more UIs 522 as input to the decision-making process. A decision subsystem 524 may gather service configuration or historical execution data from one or more databases 506 to aid in the decision-making process. A decision subsystem 524 may provide feedback to an API 520 or a UI 522.

An AI production system 530 may be used by a decision subsystem 524 in a software service 504 to assist in its decision-making process. The AI production system 530 includes one or more AI models 532 that are executed to generate a response, such as, but not limited to, a prediction, a categorization, a UI prompt, etc. In some examples and features of the instant solution, an AI production system 530 is hosted on a server. In some examples and features of the instant solution, the AI production system 530 is cloud-hosted. In some examples and features of the instant solution, the AI production system 530 is deployed in a distributed multi-node architecture.

An AI development system 540 creates one or more AI models 532. In some examples and features of the instant solution, the AI development system 540 utilizes data from one or more data sources 550 to develop and train one or more AI models 532. The data sources 550 may be local or third-party data sources. Further, the data provided by the data sources may be real-world or synthetic. In some examples and features of the instant solution, the AI development system 540 utilizes feedback data from one or more AI production systems 530 for new model development and/or existing model re-training. In some examples and features of the instant solution, the AI development system 540 resides and executes on a server. In some examples and features of the instant solution, the AI development system 540 is cloud hosted. In some examples and features of the instant solution, the AI development system 540 is deployed in a distributed multi-node architecture. In some examples and features of the instant solution, the AI development system 540 utilizes a distributed data pipeline/analytics engine.

Once an AI model 532 has been trained and validated in the AI development system 540, it may be stored in an AI model registry 560 for retrieval by either the AI development system 540 or by one or more AI production systems 530. The AI model registry 560 resides in a dedicated server in one example of the instant solution. In some examples and features of the instant solution, the AI model registry 560 is cloud-hosted. In some examples and features of the instant solution, the AI model registry 560 resides in the AI production system 530. In some examples and features of the instant solution, the AI model registry 560 is a distributed database.

FIG. 5B illustrates a process 500B for developing one or more AI models that support AI-assisted decision points. An AI development system 540 executes steps to develop an AI model 532 that begins with data extraction 541, in which data is loaded and ingested from one or more data sources 550. In some examples and features of the instant solution, historical model feedback data is extracted from one or more AI production systems 530.

Once the data has been extracted during data extraction 541, it undergoes data preparation 542 for model training. In some examples and features of the instant solution, this step involves statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 542 may be a manual process or an automated process using one or more of the elements and/or functions described and/or depicted herein.

Features of the data are identified and extracted during the feature extraction step 543. In some examples and features of the instant solution, a feature of the data is internal to the prepared data from the data preparation step 542. In some examples and features of the instant solution, a feature of the data requires a piece of prepared data from the data preparation step 542 to be enriched by data from another data source to be useful in developing the AI model 532. In some examples and features of the instant solution, identifying relevant features (relevant attributes) for model training are performed via an automated process using one or more of the elements and/or functions described and/or depicted herein. Once the features have been identified, the values of the features are collected into a dataset that will be used to develop the AI model 532.

The dataset output from the feature extraction step 543 is split 544 into a training and validation data set. The training data set is used to train the AI model 532, and the validation data set is used to evaluate the performance of the AI model 532 on unseen data.

The AI model 532 is trained and tuned 545 using the training data set from the data splitting step 544. In this step, the training data set is provided to an AI algorithm and an initial set of algorithm parameters which may be automatically determined based on the interdependence between the relevant attributes determined according to various embodiments. The performance of the AI model 532 is then tested within the AI development system 540 utilizing the validation data set from step 544. These steps may be repeated with adjustments to one or more algorithm parameters until the model's performance is acceptable based on various goals and/or results.

The AI model 532 is evaluated 546 in a staging environment (not shown) that resembles the target AI production system 530. This evaluation uses a validation dataset to ensure the performance in an AI production system 530 matches or exceeds expectations. In some examples and features of the instant solution, the validation dataset from step 544 is used. In some examples and features of the instant solution, one or more unseen validation datasets are used. In some examples and features of the instant solution, the staging environment is part of the AI development system 540, and the staging environment is managed separately from the AI development system 540. Once the AI model 532 has been validated, it is stored in an AI model registry 560, where it can be retrieved for deployment and future updates. In some examples and features of the instant solution, the model evaluation step 546 may be a manual process or an automated process using one or more of the elements and/or functions described and/or depicted herein.

In some examples and features of the instant solution, the AI development system includes a user interface (not shown). The user interface may be used to manage the development system infrastructure, the steps 541-548 within the development system, the interim data transmitted between the various steps 541-548, and the data sources 550.

Once an AI model 532 has been validated and published to an AI model registry 560, it may be deployed during the model deployment step 547 to one or more AI production systems 530. In some examples and features of the instant solution, the performance of deployed AI model 532 is monitored 548 by the AI development system 540. In some examples and features of the instant solution, AI model 532 feedback data is provided by the AI production system 530 to enable model performance monitoring 548, and the AI development system 540 periodically requests feedback data for model performance monitoring 548, which includes one or more triggers that result in the AI model 532 being updated by repeating steps 541-548 with updated data from one or more data sources 550.

FIG. 5C illustrates a process 500C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 5C, an AI production system 530 may be used by a decision subsystem 524 in software service 504 to assist in its decision-making process. The AI production system 530 provides an API 534, executed by an AI server process 536 through which requests can be made. In some examples and features of the instant solution, a request may include an AI model 532 identifier to be executed based on the type of request. In some examples and features of the instant solution, a data payload (e.g., to be input to the AI model during execution) is included in the request. The data payload may include API 520 data from software service 504, UI 522 data from software service 504 or data from other software service 504 subsystems (not shown).

Upon receiving the API 534 request, the AI server process 536 may transform 537 the data payload or portions of the data payload to be valid feature values in an AI model 532. Data transformation 537 may include, but is not limited to, combining data values, normalizing data values, and enriching the incoming data with data from other data sources 550. Once the data transformation occurs, the AI server process 536 executes the appropriate AI model 532 using the transformed input data. Upon receiving the execution result, the AI server process 536 responds to the API requester, which is a decision subsystem 524 of software service 504. In some examples and features of the instant solution, the response may result in an update to a UI 522 in software service 504. In some examples and features of the instant solution, the response includes a request identifier that can be used later by the software service 504 to provide feedback on the performance of the AI model 532. In some examples and features of the instant solution, a model feedback record may be added into a model feedback data 538 by the AI server process 536.

In some examples and features of the instant solution, the API 534 includes an interface to provide AI model 532 feedback after an AI model 532 execution response has been processed. This mechanism enables the requester to provide feedback on the accuracy of the AI model 532 results. In some examples and features of the instant solution, the feedback interface includes the identifier of the initial request so that it can be used to associate the feedback with the request. Upon receiving a call into the feedback interface of the API 534, the AI server process 536 creates and adds a model feedback record into the model feedback data 538 which holds historical model feedback records. In some examples and features of the instant solution, the records in this model feedback data 538 are provided to model performance monitoring 548 in the AI development system 540. This model feedback data is streamed to the AI development system 540 or may be provided upon request. In some examples and features of the instant solution, the model feedback records in the model feedback data 538 are used as an input for retraining the AI model 532.

In some examples and features of the instant solution, the AI production system 530 includes a user interface (not shown). The user interface may be used to manage the production system infrastructure, the components of the production system 530-538, and the operation of the AI production system and its components.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components.

What is claimed is:

1. An apparatus comprising:
a substrate;
a plurality of dynamic random-access memory (DRAM) chips disposed in a chip stack that is communicably coupled to the substrate; and
a NOT AND (NAND) flash memory chip that is included in the chip stack and which is communicably coupled to the plurality of DRAM chips.

2. The apparatus of claim 1, wherein the plurality of DRAM chips include through silicon vias (TSVs), and the NAND flash memory chip is communicably coupled to the plurality of DRAM chips within the chip stack through the TSVs.

3. The apparatus of claim 1, wherein the plurality of DRAM chips include wire bonds and the NAND flash memory chip is communicably coupled to the plurality of DRAM chips within the chip stack through the wire bonds.

4. The apparatus of claim 1, further comprising an interposer chip that is disposed in between the plurality of DRAM chips and the NAND flash memory chip within the chip stack, wherein the interposer chip is configured to translate signals sent between the plurality of DRAM chips and the NAND flash memory chip.

5. The apparatus of claim 4, wherein the interposer chip comprises logic that is configured to receive a read request from the plurality of DRAM chips and control how data is read from the NAND flash memory chip based on the read request.

6. The apparatus of claim 1, further comprising an interface chip disposed in between the plurality of DRAM chips and the substrate within the chip stack, and a processor chip that is disposed on the substrate and which is communicably coupled to the chip stack via the interface chip.

7. The apparatus of claim 6, wherein the processor chip is configured to execute an artificial intelligence (AI) process utilizing the chip stack that is communicably coupled to the processor chip.

8. A method comprising:
receiving a request for access to data stored within a chip stack that comprises a plurality of dynamic random-access memory (DRAM) chips which are communicably coupled to a substrate, and a NOT AND (NAND) flash memory chip which is communicably coupled to the plurality of DRAM chips; and
accessing the data within the chip stack based on the plurality of DRAM chips and the NAND flash memory chip within the chip stack.

9. The method of claim 8, wherein the plurality of DRAM chips include through silicon vias (TSVs), the NAND flash memory chip is communicably coupled to the plurality of DRAM chips within the chip stack through the TSVs, and the accessing the data comprises accessing the data through the TSVs.

10. The method of claim 8, wherein the plurality of DRAM chips include wire bonds, the NAND flash memory chip is communicably coupled to the plurality of DRAM chips within the chip stack through the wire bonds, and the accessing the data comprises accessing the data through the wire bonds.

11. The method of claim 8, wherein the chip stack further comprises an interposer chip that is disposed in between the plurality of DRAM chips and the NAND flash memory chip within the chip stack, the interposer chip is configured to translate signals sent between the plurality of DRAM chips and the NAND flash memory chip, and the accessing the data comprises accessing the data through the interposer chip.

12. The method of claim 11, further comprising receiving a read request for the data from the plurality of DRAM chips via the interposer chip, and controlling how the data is read from the NAND flash memory chip via the interposer chip.

13. The method of claim 8, wherein the chip stack further comprises an interface chip disposed in between the plurality of DRAM chips and the substrate within the chip stack, and the receiving the request comprises receiving the request from a processor chip that is disposed on the substrate via the interface chip.

14. The method of claim 13, further comprises executing an artificial intelligence (AI) process utilizing the processor chip and the chip stack that is communicably coupled to the processor chip via the substrate.

15. A computer-readable hardware storage medium comprising instructions which when executed by a processor cause the processor to perform:
receiving a request for access to data stored within a chip stack that comprises a plurality of dynamic random-access memory (DRAM) chips which are communicably coupled to a substrate, and a NOT AND (NAND) flash memory chip which is communicably coupled to the plurality of DRAM chips; and
accessing the data within the chip stack based on the plurality of DRAM chips and the NAND flash memory chip within the chip stack.

16. The computer-readable hardware storage medium of claim 15, wherein the plurality of DRAM chips include through silicon vias (TSVs), the NAND flash memory chip is communicably coupled to the plurality of DRAM chips within the chip stack through the TSVs, and the accessing the data comprises accessing the data through the TSVs.

17. The computer-readable hardware storage medium of claim 15, wherein the plurality of DRAM chips include wire bonds, the NAND flash memory chip is communicably coupled to the plurality of DRAM chips within the chip stack through the wire bonds, and the accessing the data comprises accessing the data through the wire bonds.

18. The computer-readable hardware storage medium of claim 15, wherein the chip stack further comprises an interposer chip that is disposed in between the plurality of DRAM chips and the NAND flash memory chip within the chip stack, the interposer chip is configured to translate signals sent between the plurality of DRAM chips and the NAND flash memory chip, and the accessing the data comprises accessing the data through the interposer chip.

19. The computer-readable hardware storage medium of claim 18, wherein the processor is further configured to perform receiving a read request for the data from the plurality of DRAM chips via the interposer chip, and controlling how the data is read from the NAND flash memory chip via the interposer chip.

20. The computer-readable hardware storage medium of claim 15, wherein the chip stack further comprises an interface chip disposed in between the plurality of DRAM chips and the substrate within the chip stack, and the receiving the request comprises receiving the request from a processor chip that is disposed on the substrate via the interface chip.
